(19) United States
(12) Patent Application Publication
(10) Pub. No.: US 2003/0204482 A1
(43) Pub. Date: Oct. 30, 2003

(54) Data search system

(76) Inventors: Yuichi Uzawa, Kawasaki (JP); Yasuhiro Ooba, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/305,803

(22) Filed: Nov. 27, 2002

(30) Foreign Application Priority Data
Apr. 30, 2002 (JP) 2002-129061

(51) Int. Cl. G06F 17/30

(52) U.S. Cl. 707/1

(57) ABSTRACT

A plurality of types of search data, such as IP addresses and port numbers are input collectively, the thus-input data is divided according to the relevant bit lengths, and, then, the divided items of data are provided to relevant entry tables. Thereby, issuance of search request from a processor to the search device, i.e., CAM device should be made only once. Then, search is made on each item of search data individually, and, as a result, the search result therefor is obtained from a respective one of the entry tables.

### BACKGROUND OF THE INVENTION

1. Field of the Invention

The present invention relates to a data search system and a data search method, especially to those used for searching for information concerning transmission destination and so forth for the purpose of performing data transmission through a telecommunications network, or the like by utilizing a destination address/port number as key information in use of a so-called CAM device, etc.

2. Description of the Related Art

When performing data transmission through a telecommunications network, such as the Internet, it is necessary to perform routing of an IP packet which flows through the network in a router or a switch used as a relay point on the network, and, generally this routing processing is performed by software and hardware. In case the routing needs to be performed especially at a high speed, a so-called CAM (Content Addressable Memory) device may be used as a so-called search engine.

In a case where the routing (switching) operation for an IP packet which flows through the Internet is performed using the CAM device, and, also, assuming a case where a so-called advanced routing service such as QoS (quality of service), etc. is applied, data to be used for the search should include not only addresses according to the layer 3 protocol but also port numbers according to the layer 4 protocol.

For example, after inputting relevant IP addresses (a source address SA and a destination address DA) into the CAM device so as to perform a search operation through the CAM device, it is necessary to again perform a search operation in order to then identify a data transmission flow to be used by inputting relevant port numbers (source port number and destination port number) according to the TCP/UDP into the CAM device.

The above-mentioned operation will now be described in detail with reference to FIG. 1. Here, it is assumed that the above-mentioned QoS or the like is applied by a network service provider, etc., and, thus, different services are prepared for a same IP address by utilizing respective special servers. In this case, router 701 acting as an entrance needs to distribute respective packets (711) input from the external network, etc. to a suitable route. Here, it is assumed that a header 731 of the input packet includes a destination IP address 731d, a source IP address 731c, a destination port address 731b, and a source port address 731a.

According to the QoS, for a destination IP address, the following different services (a) through (c) may be provided depending on a particular customer's contract beforehand made:

(a) In case it is found out that the relevant customer has made a so-called best-effort contract from the source IP address of the packet header, the relevant packet is allowed to be forwarded to a low-transfer-rate circuit 713.

(b) On the other hand, in case where a contract for a service transmitting information requiring a real-time reproduction, such as a sound, a video image, etc., the relevant packet should be forwarded to a high-transfer-rate circuit 712, while, also in this case, another type of data transmission such as ftp etc. is allowed to be forwarded to the low-transfer-rate circuit 713.

(c) In case of an access to ‘www’, according to the port number of the packet header 731, the packet is forwarded to a circuit 714 connected to an http server 704.

In order to realize such a selective service system, the search engine using the CAM device configured as shown FIG. 2 may be used. In this example, search-key data, such as IP addresses and port numbers, is input into the search engine (100) through a search-key data input bus (120) from an external processor (111 through 113), or the like. When a service system such as QoS is applied, it is necessary to determine a flow to be applied to the relevant packet based on information according to the layer 4 protocol. In this case, a search is first made by using the IP addresses (SA, DA) on the layer 3, and, after that, the CAM device is again used for a further search by using the port numbers on the layer 4.

In the example of FIG. 2, when the processor of (111) performs a search by inputting the IP addresses first, for example, an entry (104) of the CAM device (101) is hit, and as a result, corresponding data (106) in a context RAM (102) is output (103) therefrom. Thereby, a relevant user's contract information is obtained. Furthermore, after that, the processor (111) performs a further search by then inputting the port numbers, such as those according to TCP/UDP. As a result, an entry (105) in the CAM device (101) is hit, the corresponding data (107) in the context RAM (102) is thus output (103) therefrom. Thereby, determination of the flow can then be made.

A case will now be discussed where a router or a switch on the network is configured by using such a search engine. In this case, a method will now be discussed where one search engine is shared by a plurality of processors in order to achieve simplification of maintenance of a routing table, or cost reduction. By applying this method, assuming a case where parallel processing on a plurality of channels is carried out, search requests are given to the search engine from the processors which deal with the respective channels with respect to information (path/route information etc.) extracted from relevant packets. Further assuming that the QoS, etc. is applied, after the search is requested with respect to the IP addresses, a further search with respect to the port numbers is required from each relevant processor.

When such parallel processing is performed by the respective processors (111-113) simultaneously, collision may occur in the data bus (120) of the shared search engine or CAM device as similar requests are made by the respective processors. In this case, in order to prevent collision, it is required to perform a complicated control concerning the order of processing tasks required by the respective processors.

Furthermore, in case of the QoS is applied, it is necessary to provide entries with respect to both the IP addresses and port numbers. In case of the IPv4 address system currently applied is discussed, the required bit length is obtained by the following calculation: IP addresses (SA: 32 bits, DA: 32 bits)+port numbers (16 bits+16 bits)=96 bits. In case of the Ipv6 address system, the 128 bit length is needed only with respect to the IP addresses.

Although a currently-available CAM device has a configuration such as to be able to execute a long-bit-length search operation, the number of entries which can be provided by a limited memory capacity should be remarkably reduced. Furthermore, as a plurality of port numbers may exist for each IP-address pair, a very large number of entries are needed for determining packet transmission flows corresponding to these port numbers.

In order to cope with such a demand for a large number of entries, a method of providing a memory for IP addresses and another memory for port numbers separately in the CAM device may applied such that the storage load is shared thereby. However, even in such a scheme, total two search operations are needed to be performed, i.e., a first search with respect to IP addresses and a second search with respect to port numbers. Thereby, the operation procedure is still complicated.

FIG. 3 is a flow chart which shows an operation of the processor in this case. Here, a search command having the destination address and the source address as a search key is issued in a step S1, first. Input bus arbitration processing for the search engine is performed is in a step S2. As a result, the search result is obtained from the search engine, and information concerning the transmission person (contractor) is acquired from this search result (in a step S3). Next, in a step S4, a search command by the destination port number and the source port number is issued. Input bus arbitration for the search engine is then performed in a step S5. As a result, the search result is obtained and the information concerning the applied service class is acquired from this search result (in a step S6). Thus, according to the related art; total two search requests in the steps S2 and S5 should be issued.

Japanese patent application No. 11-120776 discloses a configuration in which the number of available entries is made increase by making cascade connection of a plurality of CAM arrays. However, in this configuration, as operation of transferring a search result output from each CAM array to a subsequent CAM array is performed one by one, it is expected that an extra time is required until a final search result is obtained.

### SUMMARY OF THE INVENTION

The present invention is made in view of the above-mentioned problems, and it aims at providing a data search arrangement and search method of dealing with a demand for high-speed search processing with a comparatively simple configuration employing a CAM device, or the like.

According to the present invention, a plurality of types of search data, such as IP addresses and port numbers are input collectively, the thus-input data is divided according to the relevant bit lengths, and, then, the divided items of data are provided to relevant memory data parts (entry tables). Then, a search is made according to thus-given each item of search data individually on the entry table, and, as a result, the search result therefor is obtained therefrom. It is also possible that, by using these search results as addresses, required information stored in a context RAM is obtained.

Other objects and further features of the present invention will become more apparent from the following detailed description when read in conjunction with the accompanying drawings.

### BRIEF DESCRIPTION OF THE DRAWINGS

FIG. 1 illustrates a routing system in a communications network to which the present invention may be applied;

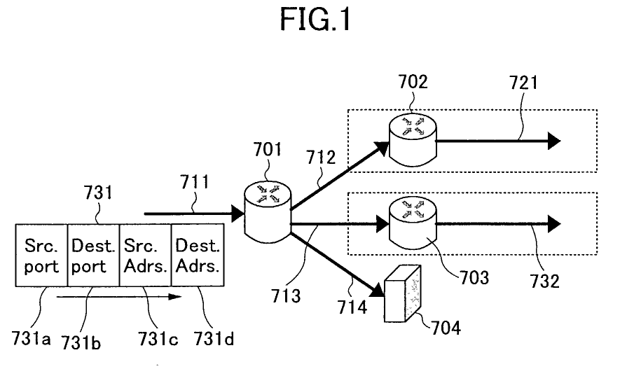

FIG. 2 illustrates a search system employing a CAM device according to the related art;

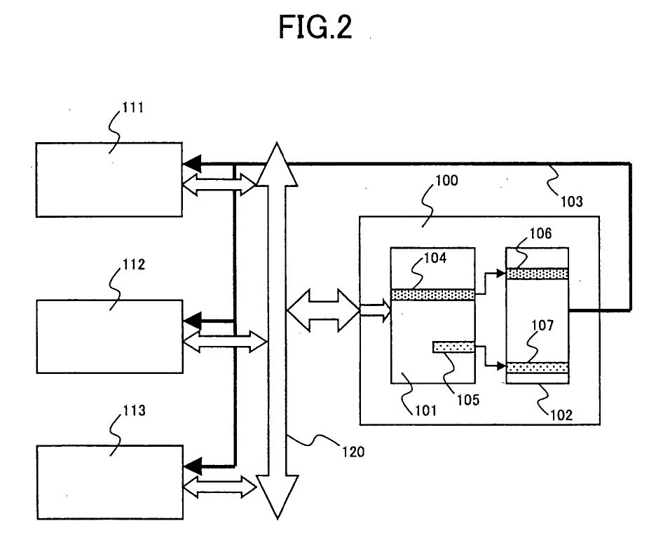

FIG. 3 shows a flow chart illustrating a search operation performed in the system shown in FIG. 2;

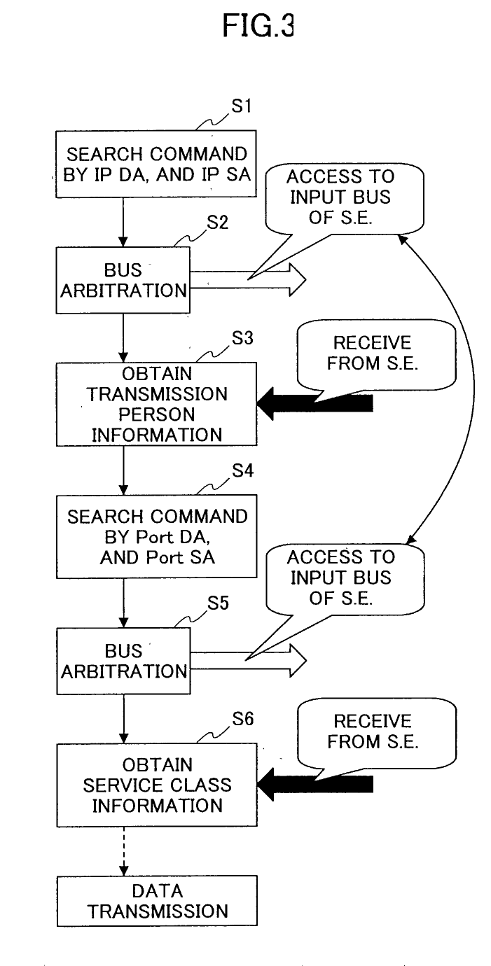

FIG. 4 shows a flow chart illustrating a search operation according to the present invention;

FIG. 5 shows a block diagram illustrating a general configuration of a first embodiment of the present invention;

FIG. 6 shows a block diagram illustrating a general configuration of a second embodiment of the present invention;

FIG. 7 shows a block diagram illustrating a general configuration of a third embodiment of the present invention;

FIG. 8 shows a block diagram illustrating a general configuration of a fourth embodiment of the present invention; and

FIG. 9 shows a block diagram illustrating a general configuration of a fifth embodiment of the present invention.

### DETAILED DESCRIPTION OF THE PREFERRED EMBODIMENTS

According to the present invention, in case a search is made by using IP addresses, port numbers, etc. as search key information as mentioned above, these IP addresses and the TCP/UDP port group are collectively input, and thus, required search results can be obtained by issuing one search request to the CAM device.

That is, in order to deal with one search demand from the outside, entry groups such as IP addresses and port numbers are individually held in the CAM device, and search operations by using as search information both the IP addresses and port numbers input from the external processor are individually performed in the CAM device. Thereby, it becomes possible to eliminate necessity issuance of a plurality of times of search requests for respective ones of the IP addresses and port numbers.

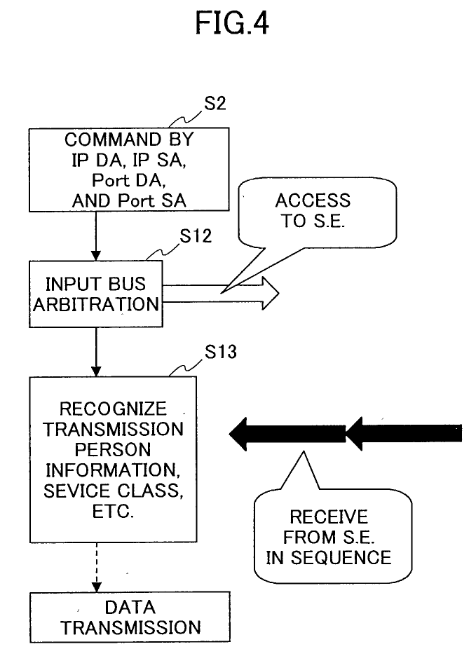

FIG. 4 shows a flow chart of the operations. In a step Sil, a search command is issued with all the IP addresses and port numbers as search key information. Input bus arbitration for the search engine is performed in a step S12. Then, respective search results with respect to all the search keys set in the step S11 are obtained from the search engine in a step S13, and, thus, necessary information for determining conditions applied for performing relevant information transmission is obtained, i.e., conditions concerning the transmission person, a relevant QoS service class to be applied, and so forth can be recognized.

This method may also be applied to VLAN or layer-2-protocol switching processing. Further, in case the search method according to the present invention is applied to a situation where a common search engine is shared by a plurality of processors, it is preferable to add information for identifying a processor to which data obtained as a search result should be sent as will be described later. Consequently, bus control such as data processing order control, control of distribution of data to respective processors, etc. can be made easier.

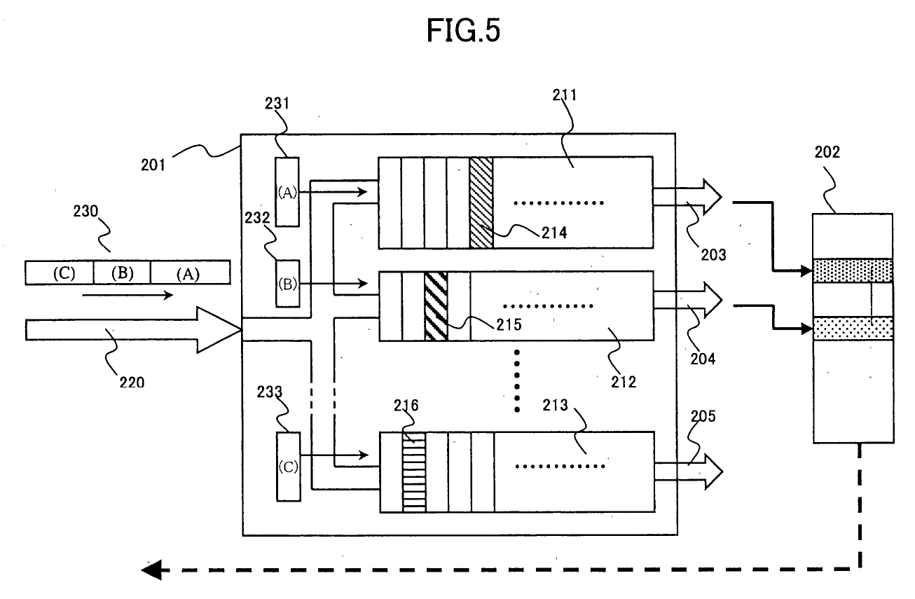

A basic configuration of a CAM device (201) according to a first embodiment of the present invention conceptually described above is shown in FIG. 5. First, search data (A), (B), and (C) is input externally (from a processor and so forth) into an input bus (220). This search data includes IP addresses, port numbers, MAC address, etc., each having different bit length.

The search data thus input collectively is divided into respective bit lengths, i.e., 231 (A), 232 (B), and 233 (C), and so forth, which are then applied to respective sets of memory data (211, 212, 213), i.e., respective entry tables (211, 212, 213), held in-the CAM device 201 as collections of data to be searched. That is, the search data (A) is applied to the entry table 211 which includes a group concerning the data (A), the search data (B) is applied to the entry table 212 which includes a group concerning the data (B), and the search data (C) is applied to the entry table 213 of a group concerning the data (C). Then, a search is made on each entry table 211, 212 and 213 with respect to the relevant key, i.e., the data (A), (B) and (C), in parallel, independently, according-to a well-know manner for using a common CAM device.

The entry tables 211, 212 and 213 for the respective above-mentioned groups may beforehand be set into the CAM device by, for example, a method of physically dividing a CAM cell array, and setting each entry table into a respective division thereof, individually. Alternatively, it is also possible to logically divide a CAM cell array, and set each entry table into a relevant division thereof individually.

In the search by the search data 231, for example, it is assumed that an entry 214 is hit in the entry table 211. In this case, corresponding information is output (203) therefrom. Similarly, by the search with the search data 232, it is assumed that an entry 215 is hit, and, corresponding information is output (204) therefrom. Also, it is assumed that an entry 216 is hit and corresponding information is output (205) in the search by the search data 233. The thus-output information is then sent to and used as addresses (or an address) on a context RAM 202 beforehand set, and, thus, from the context RAM 202, information stored in the thus-provided addresses (or address) thereof is then returned to the processor which first issued the relevant search command.

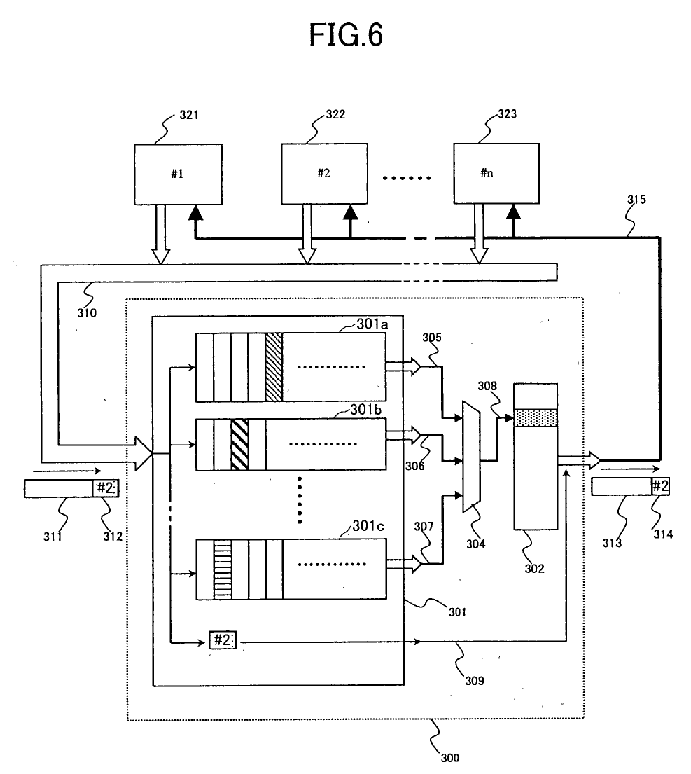

With reference to FIG. 6, a second embodiment of the present invention will now be described. In the second embodiment, n processors 321, 322, 323, . . . , and n share a search engine 300. For example, it is assumed that a processor (322) issues a search request. In this case, search data 311 and processor identification information (#2) 312 (simply referred to as ID, hereinafter) are sent to the search engine 300 through an input bus 310. Inside a CAM device 301 of the search engine 300, the thus-input search data 311 is divided according to predetermined bit lengths of respective items of search data included in the search data 311. Then, by using key information obtained from the above-mentioned dividing operation, search operations are performed on relevant entry tables 301a, 301b, and 301c, respectively, included in the CAM device 301. Then, the search results (305, 306 and 307) thereof are output therefrom as the manner same as in the first embodiment described above.

These outputs 305, 306 and 307 are provided to an address port (308) of a context RAM 302 through a multiplexer 304 which forms an address of the context RAM 302 by combining the search results 305, 306 and 307. Thereby, relevant contents (313) of the context RAM 302 with respect to the address thus formed through the multiplexer 304 as a search result are returned to the relevant processor from an output port 315 of the search engine 300 together with the above-mentioned ID (#2) 309. In this example, since ID is #2, the processor #2 (322) which first issued the relevant search request then receives the contents 313.

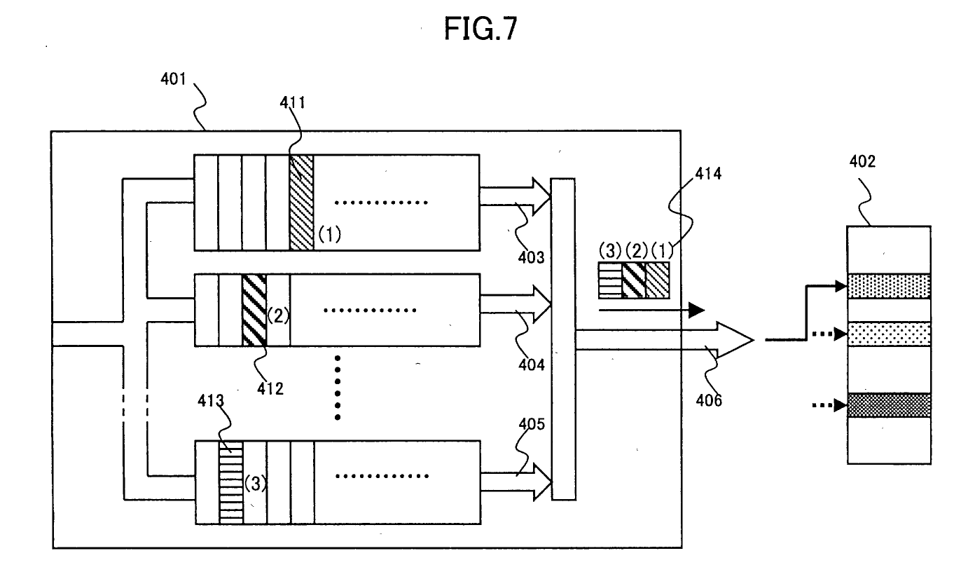

With reference to FIG. 7, a third embodiment of the present invention will now be described. According to the third embodiment, in a CAM device 401, it is assumed that, with respect to input search data (key information), entries (1), (2), and (3) (411, 412 and 413) are hit, and, then, relevant information (403, 404 and 405) is output from the respective hit entries of the entry tables, for example. In this case, the CAM device 401 outputs the information acquired on these hits at a time-division manner (414). Thereby, it is possible to reduce the number of output ports 406 of the CAM device 401 effectively. The time-division manner may be achieved by employing a multiplexer such as that 304 shown in FIG. 6, or the like, for example. However, in this case, respective search results (1), (2) and (3) may indicate separate particular addresses of the context RAM 402, as shown in the figure.

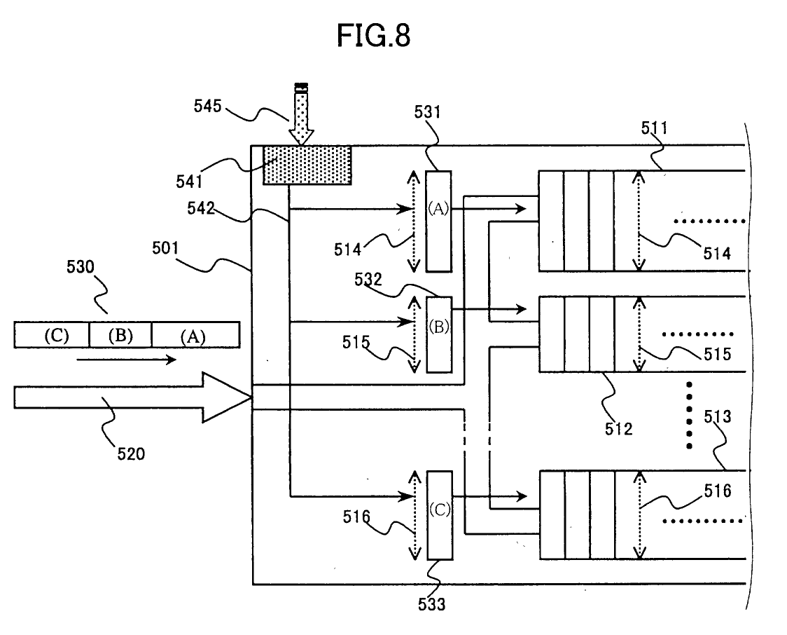

With reference to FIG. 8, a fourth embodiment of the present invention will now be described. In this embodiment, in an input part of a CAM device (501), for input search data (key information) 530 to receive, predetermined information as to how this data is to be divided is beforehand set, for example, in an internal register 541 in the CAM device 501. Then, based thereon, division bit lengths are determined.

That is, according to the fourth embodiment, after such division manner data is set beforehand, and then, an operation of search engine is performed in the manner same as in the above-described embodiments, after search data (key information) is input according to a predetermined format from an input port (520). Since the division manner is beforehand set as mentioned above, the input search data is divided into divisions of search data (531, 532 and 533) which have respective bit lengths 514, 515 and 516, according to the above-mentioned division manner. For example, the divisions of search data 531, 532 and 533 include IP addresses, port numbers, MAC addresses, etc., are then applied to respective ones of predetermined entry tables (511, 512 and 513) in the CAM device 501, and as-a result, search operations are performed thereon, respectively. The other configuration of the CAM device is the same as that of the CAM device 401 according to the third embodiment described above with reference to FIG. 7.

Thus, according to the fourth embodiment, the data concerning the division manner with respect to input search data is beforehand set in the internal register, or the like. However, as an alternative scheme, it is also possible to input such data concerning a division manner from the outside via an external setting port 545 of the CAM device 501. In this case, the external setting port 545 should not be specially provided, but the relevant data may be input in a form of a command via a port 520 which is originally used for the search data input.

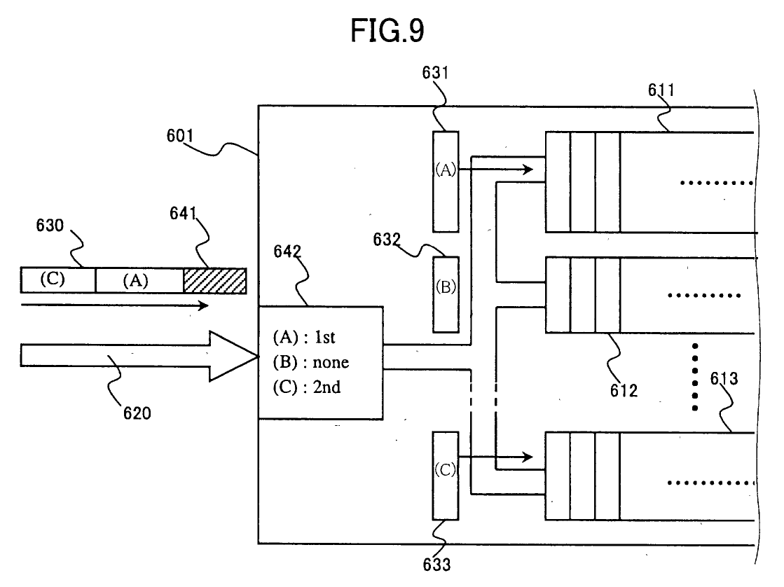

With reference to FIG. 9, a fifth embodiment of the present invention will now be described. According to the fifth embodiment, when search data (key information) 630 is input from an input port 620 of an input portion of a CAM device (601), information (641), such as that concerning a configuration of this search data and bit length of each data component thereof is input together with the search data 630 itself. Further, in this embodiment, an analysis part 642 which carries out analysis and interpretation of the information (641) is provided in the CAM device 601.

Then, assuming that the configuration of the input search data 630 is that including data components according to data formats (A) and (C), the analysis part 642 analyses the information 641, and, thus, recognizes that the input data has the first data in the data format (A), has no data in a (B) data format, and has the second data in the data format (C). After that, these data components (A) and (C) (631 and 633) are applied to the corresponding entry tables 611 and 613, respectively, as search data (key information), and search operations thereon are performed, respectively.

According to the fifth embodiment, even when different types of data (having different bit lengths, or the like) are input, the configurations thereof are analyzed by the analysis part 642. Thereby, the input search data (key information) can be appropriately divided, and the thus-obtained divisions of data can thus be appropriately distributed into the relevant entry tables for the search operations thereon, respectively. Accordingly, desired search operations can be performed positively and properly in the CAM device.

By using the CAM device according to the present invention described above, it is possible to build a system having functions of both a multiprocessor and a search engine, as shown in FIG. 6.

The present invention is not limited to the above-described embodiments, and variations and modifications may be made without departing from the scope of the present invention.

The present application is based on Japanese priority application No. 2002-129061, filed on Apr. 30, 2002, the entire contents of which are hereby incorporated by reference.

What is claimed is:

1. A search apparatus comprising:
a plurality of search parts provided for respective ones of a plurality of units of given search data, said plurality of search parts performing search operations with respect to the plurality of units of given search data, respectively, individually; and
a distribution part distributing the collectively input plurality of units of given data into the corresponding ones of said plurality of search parts.

2. The search apparatus as claimed in claim 1, further comprising a time-division output part performing time-division multiplexing of respective search results output from the plurality of search parts so as to output the multiplexed output via a single output port.

3. The search apparatus as claimed in claim 1, further comprising a memory part storing data at respective addresses,
wherein search results output from said plurality of search parts are used as addresses or an address of-said memory part so that corresponding collections of data or a corresponding collection of data is output from said memory part.

4. The search apparatus as claimed in claim 1, wherein:
identification information is input together with the plurality of units of given search data, and, the identification data is output together with the search results, the identification information being used for identifying a destination to which the search results are to be provided.

5. The search apparatus as claimed in claim 3, wherein:
identification information is input together with the plurality of units of given search data, and, the identification data is output together with the data output from said memory part, the identification information being used for identifying a destination to which the search results are to be provided.

6. The search apparatus as claimed in claim 3, further comprising a selection part selecting the search results output from the plurality of search parts in sequence, and outputs the thus-selected ones accordingly,
wherein the selected ones output from said selection part are used as respective addresses or an address of said memory part.

7. The search apparatus as claimed in claim 6, wherein said selecting part comprises a multiplexer.

8. The search apparatus as claimed in claim 1, further comprising a distribution information setting part in which information used for determining a manner of distributing the plurality of units of given search data into said plurality of search parts is beforehand set.

9. The search apparatus as claimed in claim 1, information used for determining a manner of distributing the plurality of units of given search data into said plurality of search parts is input externally.

10. The search apparatus as claimed in claim 1, information used for determining a manner of distributing the plurality of units of given search data into said plurality of search parts is input as being attached to a collection of the plurality of units of given search data

11. The search apparatus as claimed in claim 1, wherein said distributing part performs the distribution operation according to information indicating predetermined bit lengths of the plurality of units of given search data input collectively.

12. A search method comprising the steps of:
a) providing a plurality of search parts for respective ones of a plurality of units of given search data so as to perform therethrough search operations with respect to the plurality of units of given search data, respectively, individually; and
b) distributing the collectively input plurality of units of given data into the corresponding ones of said plurality of search parts.

13. The search method as claimed in claim 12, further comprising the step c) of performing time-division multiplexing of respective search results output from the plurality of search parts so as to output the multiplexed output via a single output port.

14. The search method as claimed in claim 12, further comprising the step c) of using search results output from said plurality of search parts as addresses or an address of a memory part, respectively so as to obtain from said memory part corresponding data.

15. The search method as claimed in claim 12, further comprising the steps of:
c) inputting identification information together with the plurality of units of given search data, the identification information being used for identifying a destination to which the search results are to be sent;
d) outputting the identification information together with the search results.

16. The search method as claimed in claim 14, further comprising the steps of:
d) of inputting identification information together with the plurality of units of given search data, the identification information being used for identifying a destination to which the search results are to be provided; and
e) outputting the identification information together with the data output from said memory part.

17. The search method as claimed in claim 14, further comprising the step d) of selecting the search results output from the plurality of search parts in sequence to be used as respective addresses or an address of said memory part.

18. The search apparatus as claimed in claim 12, further comprising the step c) of beforehand setting information used for determining a manner of distributing the plurality of units of given search data into said plurality of search parts.

19. The search method as claimed in claim 12, further comprising the step c) of externally inputting information used for determining a manner of distributing the plurality of units of given search data into said plurality of search parts.

20. The search method as claimed in claim 12, further comprising the step c) of inputting information used for determining a manner of distributing the plurality of units of given search data into said plurality of search parts as being attached to a collection of the plurality of units of given search data

21. The search method as claimed in claim 12, wherein said step b) performing the distribution operation according to given information indicating predetermined bit lengths of the plurality of units of search data input.

22. A data processing system comprising:
a plurality of processors each providing a collection of a plurality of units of search data;
a plurality of entry tables each having a plurality of entries together with respective addresses; and
a distributing device receiving the collection of the plurality of units of search data, and then, distributing them into respective ones of said plurality of entry tables;
wherein:
each unit of search data of the plurality of units of search data distributed into a respective one of said plurality of entry tables is used as a key for searching said entry table for a corresponding entry; and
the address of the thus-searched-for entry is output as a search result to the processor which has issued the collection of the plurality of units of search data.

23. The data processing system as claimed in claim 22, further comprising a time-division output part performing time-division multiplexing of respective search results output from the plurality of entry tables so as to output the multiplexed output via a single output port.

24. The data processing system as claimed in claim 22, further comprising a context memory part storing data at respective addresses,
wherein search results output from said plurality of entry tables are used as respective addresses or an address of said context memory part so that corresponding data is acquired and output from said context memory part.

25. The data processing system as claimed in claim 22, wherein:
identification information is input together with a collection of the plurality of units of search data, and, the identification data is output together with the search results, the identification information being used for identifying a relevant one of said plurality of processors to which the search results are to be provided.

26. The data processing system as claimed in claim 24, wherein:
identification information is input together with a collection of the plurality of units of given search data, and, the identification data is output together with the data output from said context memory part, the identification information being used for identifying a relevant one of said plurality of processors to which the data output from said context memory part is to be provided.

27. The data processing system as claimed in claim 24, further comprising a selection part selecting the search results output from the plurality of entry tables in sequence, and outputs the thus-selected ones accordingly,
wherein the selected-ones output from said selection part are used as addresses or an address of said context memory part.

28. The data processing system as claimed in claim 27, wherein said selecting part comprises a multiplexer.

29. The data processing system as claimed in claim 22, further comprising a distribution information setting part in which information used for determining a manner of distributing the plurality of units of given search data into said plurality of entry tables is beforehand set.

30. The data processing system as claimed in claim 22, wherein information used for determining a manner of distributing the plurality of units of given search data into said plurality of entry tables is input externally.

31. The data processing system as claimed in claim 22, wherein information used for determining a manner of distributing the plurality of units of given search data into said plurality of entry tables is input as being attached to the plurality of units of given search data

32. The data processing system as claimed in claim 22, wherein said distributing part performs the distribution operation according to given information indicating predetermined bit lengths of the respective ones of the plurality of units of given search data.

33. The data processing system as claimed in claim 24, wherein:
said context memory part stores information concerning user details; and
the search data issued by each of said plurality of processors comprises IP addresses and port numbers included in a given IP packet;
said plurality of entry tables are provided each item of the given IP addresses and port numbers included in the search data, respectively, and provide, in response to the search data as search keys, respective addresses of said context memory part;
said context memory part provides, in response to the addresses provided from said plurality of entry tables, contents corresponding to the thus-provided addresses, said contents comprising the user details to be used for determining data transmission conditions; and
the processor which has originally issued the relevant search data controls transmission of the given IP packet according to the data transmission conditions determined according to the. contents thus obtained from said context memory.

34. The data processing system as claimed in claim 33, wherein:
the data transmission conditions, according to which transmission of the given IP packet is controlled, comprise quality of service conditions by which data transmission requirements to be satisfied concerning the transmission of the relevant IP packet are determined.

35. A content addressable memory device comprising:
a plurality of search parts provided for respective ones of a plurality of units of given search data, said plurality of search parts performing search operations with respect to the plurality of units of given search data, respectively, individually; and
a distribution part distributing the collectively input plurality of units of given data into the corresponding ones of said plurality of search parts.
